(19) United States
(12) Patent Application Publication
(10) Pub. No.: US 2015/0017551 A1
(43) Pub. Date: Jan. 15, 2015

(54) USE OF LITHIUM SALT MIXTURES AS LI-ION BATTERY ELECTROLYTES

(71) Applicant: ARKEMA FRANCE, Colombes (FR)

(72) Inventor: Grégory Schmidt, Columbes Cedex (FR)

(73) Assignee: ARKEMA FRANCE, Colombes (FR)

(21) Appl. No.: 14/359,888

(22) PCT Filed: Nov. 21, 2012
(86) PCT No.: PCT/FR2012/052681

§ 371 Date: May 21, 2014

(30) Foreign Application Priority Data
Dec. 6, 2011 (FR) 11.61204
May 31, 2012 (FR) 12.55046

(51) Int. Cl. H01M 10/0568; H01M 10/0525; H01M 10/0569

(52) U.S. Cl. CPC H01M 10/0568; H01M 10/0569; H01M 10/0525; H01M 2300/0025; H01M 2300/0037; H01M 2220/20
USPC 429/326; 429/188; 429/199; 429/200; 429/341

(57) ABSTRACT

Lithium salt mixtures, for example a mixture including at least two lithium salts chosen from two of the three following groups of salts: X: LiPF₆, LiBF₄, CH₃COOLi, CH₃SO₃Li, CF₃SO₃Li, CF₃COOLi, Li₂B₁₂F₁₂, LiBC₄O_{8;} R₁—SO₂—NLi—SO₂—R₂, where R₁ and R₂ independently represent F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃; or Formula (I), where Rf represents F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃. Also, said salt mixtures dissolved in solvents, suitable for being used as electrolytes for Li-ion batteries.

### CROSS REFERENCE TO RELATED APPLICATIONS

The present application is a U.S. National Stage Application of International Application No. PCT/FR2012/052681, filed on Nov. 21, 2012, which claims the benefit of French Application No. 11.61204, filed on Dec. 6, 2011, and French Application No. 12.55046, filed on May 31, 2012. The entire contents of each of International Application No. PCT/FR2012/052681, French Application No. 11.61204, and French Application No. 12.55046 are hereby incorporated herein by reference in their entirety.

### TECHNICAL FIELD

Embodiments of the present disclosure relates to mixtures of lithium salts and to its use as electrolytes for a battery of Li-ion type.

### TECHNICAL BACKGROUND

A lithium-ion battery comprises at least a negative electrode (anode), a positive electrode (cathode), a separator and an electrolyte. The electrolyte is generally composed of a lithium salt dissolved in a solvent which is generally a mixture of organic carbonates, in order to have a good compromise between the viscosity and the dielectric constant. Additives can subsequently be added in order to improve the stability of electrolyte salts.

The most widely used salts include lithium hexafluorophosphate (LiPF₆), which has many of the numerous qualities required but exhibits the disadvantage of decomposing in the form of a hydrofluoric acid gas by reaction with water. This presents safety problems, in particular in the context of the impending use of lithium-ion batteries in private vehicles.

Other salts have thus been developed such as LiTFSI (lithium bis(trifluoromethanesulfonyl)imide) and LiFSI (lithium bis(fluorosulfonyl)imide). These salts exhibit little or no spontaneous decomposition and are more stable with regard to hydrolysis than LiPF₆. Nevertheless, LiTFSI exhibits the disadvantage of being corrosive with regard to aluminum current collectors, which is not the case with LiFSI. Thus, LiFSI appears to be a promising alternative to LiPF₆ but its cost currently limits its use.

Recently, other salts have been developed, such as LiTDI (lithium 4,5-dicyano-2-(trifluoromethyl)imidazolate) and LiPDI (lithium 4,5-dicyano-2-(pentafluoroethyl)imidazolate). These salts exhibit the advantages of having fewer fluorine atoms and of having strong carbon-fluorine bonds instead of the weaker phosphorus-fluorine bonds of LiPF₆. Furthermore, the document WO2010/023413 shows that these salts exhibit conductivities of the order of 6 mS/cm, a very good dissociation between the imidazolate anion and the lithium cation and their use as electrolyte salt for Li-ion batteries.

The preparation of the salts is described in the documents WO2010/023143, WO 2010/113483, WO 2010/113835 and WO 2009/123328.

The applicant company has discovered that the use of a mixture of the salts described above makes it possible to partially or completely overcome the disadvantages found when they are used in isolation.

The mixture can comprise at least two different salts.

### SUMMARY

Embodiments of the disclosure relates first to a mixture of lithium salts.

Another embodiment of the disclosure is the mixture of salts dissolved in a solvent.

An additional embodiment of the disclosure is the use of said mixture as electrolyte for Li-ion storage batteries composed of an anode, of a cathode and of a separator. The anode can be lithium metal, graphite, carbon, carbon fibers, an alloy, Li₄Ti₅O₁₂ or a mixture of at least two of the abovementioned. The cathode can be a lithium-based oxide, a lithium-based phosphate, a lithium-based fluorophosphate, a lithium-based sulfate or a lithium fluorosulfate. In addition to the lithium, one or more transition metals can be present, for example LiCoO₂, LiFePO₄, LiMn_{1/3}Co_{1/3}Ni_{1/3}O₂, LiFePO₄F and LiFeSO₄F. The cathode can also be a mixture of at least two of the abovementioned compounds.

Embodiments of the disclosure make it possible to overcome the disadvantages of salts described above. It more particularly provides a mixture of lithium salts, which are capable of being used as electrolyte for Li-ion batteries.

The mixture according to an embodiment of the disclosure comprises at least two lithium salts chosen from two of the three following groups of salts:
X: LiPF₆, LiBF₄, CH₃COOLi, CH₃SO₃Li, CF₃SO₃Li, CF₃COOLi, Li₂B₁₂F₁₂, LiBC₄O₈
R₁—SO₂—NLi—SO₂—R₂, where R₁ and R₂ independently represent F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃
Formula (I), where Rf represents F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃.

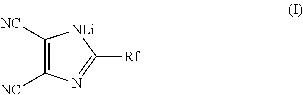

The mixture according to an embodiment of the disclosure preferably comprises at least one lithium salt of formula (I) where Rf represents F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃ and at least one lithium salt chosen from the X group or the R₁—SO₂—NLi—SO₂—R₂ group where R₁ and R₂ independently represent F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃.

According to a preferred embodiment of the disclosure, the mixture comprises at least one lithium salt of formula (I) where Rf represents F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃ and at least one lithium salt chosen from the X group.

According to another preferred embodiment of the disclosure, the mixture comprises at least one lithium salt of formula (I) where Rf represents F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃ and at least one lithium salt chosen from the R₁—SO₂—NLi—SO₂—R₂ group where R₁ and R₂ independently represent F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃.

According to a preferred alternative form of the disclosure, the mixture comprises at least one lithium salt chosen from the X group and at least one lithium salt chosen from the R₁—SO₂—NLi—SO₂—R₂ group where R₁ and R₂ independently represent F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃.

Advantageously, the mixture according to embodiments of the disclosure comprises at least one lithium salt of formula (I) where Rf represents F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃, at least one lithium salt chosen from the X group and at least one lithium salt chosen from the R₁—SO₂—NLi—SO₂—R₂ group where R₁ and R₂ independently represent F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃.

Whatever the embodiment or alternative form, the particularly preferred compound of the X group is LiPF₆.

Whatever the embodiment or alternative form, the particularly preferred Rf of formula (I) is F, CF₃, CHF₂, C₂F₅, C₂F₄OCF₃, C₂H₂F₂OCF₃ or CF₂OCF₃.

Whatever the embodiment or alternative form, the lithium salt of the R₁—SO₂—NLi—SO₂—R₂ group where R₁ and R₂ independently represent F, CF₃, C₂F₅, C₂F₄OCF₃, C₂H₂F₂OCF₃ or CF₂OCF₃ is particularly preferred.

The amount of each lithium salt present in the mixture can vary within wide limits and generally represents between 1% and 99% by weight, with respect to the total weight of the salts present in the mixture, preferably between 5% and 95% by weight.

Another embodiment of the disclosure is the mixture of salts dissolved in a solvent or several solvents, preferably carbonates, glymes, nitriles and dinitriles or fluorinated solvents.

Mention may in particular be made, as carbonates, of ethylene carbonate, dimethyl carbonate, ethyl methyl carbonate, diethyl carbonate or propylene carbonate.

Mention may in particular be made, as glymes, of ethylene glycol dimethyl ether, diethylene glycol dimethyl ether, dipropylene glycol dimethyl ether, diethylene glycol diethyl ether, triethylene glycol dimethyl ether, diethylene glycol dibutyl ether, tetraethylene glycol dimethyl ether and diethylene glycol t-butyl methyl ether.

Mention may in particular be made, as nitriles and dinitriles, of acetonitrile, propionitrile, isobutyronitrile, valeronitrile, malononitrile, succinonitrile, or glutaronitrile.

Mention may in particular be made, as fluorinated solvents, of the preceding solvents: carbonates, glymes, nitriles and dinitriles at which at least one hydrogen atom has been replaced by a fluorine atom.

The proportions by weight of each of the constituents, which are defined as the ratio of the weight of a constituent to the total weight of all the constituents of the solvent, are preferably between 1 and 10, with respect to the constituent in the smallest amount, more preferably between 1 and 8.

The mixture according to embodiments of the disclosure results in a maximum ion conductivity, electrochemical stability and retention of capacity and in a minimum irreversible capacity. The mixture is prepared from the corresponding lithium salts. When a solvent is present, the preparation is carried out by dissolving, preferably with stirring, the lithium salts constituting the mixture in appropriate proportions of solvents.

The applicant company has noticed, surprisingly, that the use of the mixtures of salts described above dissolved in appropriate proportions in a solvent as electrolyte for lithium-ion storage batteries does not exhibit the disadvantages observed when the salts are individually dissolved in a solvent.

Thus, LiPF₆ reacts violently with water to form HF, which results in dissolution of the cathode materials. LiPF₆ can also decompose to give PF₅, a Lewis acid, which can result in the decomposition of the carbonates used as solvents, thus bringing about a loss in the capacity of the battery.

The salts of the R₁—SO₂—NLi—SO₂—R₂ type exhibit the disadvantage of being corrosive for the aluminum current collector within potential ranges where the Li-ion battery is employed. Furthermore, these salts show excellent ion conductivities for some R groups.

The salts of formula (I) exhibit the advantage of not being corrosive toward the aluminum current collector and of forming a stable passivation layer on the current collective but have a low ion conductivity of the order of half that of LiPF₆. Furthermore, these salts also appear to be capable of readily capturing water molecules.

### EXAMPLE

In the light of the disadvantages and advantages of the various types of lithium salts, synergies clearly appear, as by the following non-limiting examples, for the disclosure.

### Example 1

The first mixture produced consists in dissolving, at ambient temperature, a salt mixture comprising 80% by weight of F—SO₂—NLi—SO₂—F (LiFSI) and 20% by weight of a salt of formula (I) where Rf=CF₃ (LiTDI) in a mixture of three carbonates: ethylene carbonate, dimethyl carbonate and propylene carbonate, in respective proportions by weight of ⅓, ⅓ and ⅓. This mixture gives a high ion conductivity and results in a passivation layer on the aluminum current collector.

### Example 2

The second mixture produced is composed of 50% by weight of an LiTDI salt and of 50% by weight of LiPF₆. These two salts are dissolved in a mixture of two carbonates: ethylene carbonate and dimethyl carbonate, in respective proportions by weight of ⅓ and ⅔. This mixture gives a high ion conductivity without decomposing the LiPF₆.

### Example 3

The third mixture produced consists in dissolving a mixture of salts containing 60% by weight of CF₃—SO₂—NLi—SO₂—CF₃ (LiTFSI) and 40% by weight of LiTDI in a mixture of three carbonates: ethylene carbonate, dimethyl carbonate and propylene carbonate in respective proportions by weight of ⅓, ⅓ and ⅓. This mixture gives a high ion conductivity and results in a passivation layer formed on the aluminum current collector.

1. A mixture comprising at least two lithium salts chosen from two of the three following groups of salts:
X: LiPF₆, LiBF₄, CH₃COOLi, CH₃SO₃Li, CF₃SO₃Li, CF₃COOLi, Li₂B₁₂F₁₂, LiBC₄O₈;
R₁—SO₂—NLi—SO₂—R₂, where R₁ and R₂ independently represent F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃; or
Formula (I), where Rf represents F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃

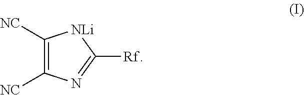

2. The mixture as claimed in claim 1, comprising at least one lithium salt of formula (I) where Rf represents F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃ and at least one lithium salt chosen from the X group or the R₁—SO₂—NLi—SO₂—R₂ group where R₁ and R₂ independently represent F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃.

3. The mixture as claimed in claim 2, comprising at least one lithium salt of formula (I) where Rf represents F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃ and at least one lithium salt chosen from the X group.

4. The mixture as claimed in claim 2, comprising at least one lithium salt of formula (I) where Rf represents F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃ and at least one lithium salt chosen from the R₁—SO₂—NLi—SO₂—R₂ group where R₁ and R₂ independently represent F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃.

5. The mixture as claimed in claim 1, comprising at least one lithium salt chosen from the X group and at least one lithium salt chosen from the R₁—SO₂—NLi—SO₂—R₂ group where R₁ and R₂ independently represent F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃.

6. The mixture as claimed in claim 1, comprising at least one lithium salt of formula (I) where Rf represents F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃, at least one lithium salt chosen from the X group and at least one lithium salt chosen from the R—SO₂—NLi—SO₂—R group where R represents F, CF₃, CHF₂, CH₂F, C₂HF₄, C₂H₂F₃, C₂H₃F₂, C₂F₅, C₃F₇, C₃H₂F₅, C₃H₄F₃, C₄F₉, C₄H₂F₇, C₄H₄F₅, C₅F₁₁, C₃F₅OCF₃, C₂F₄OCF₃, C₂H₂F₂OCF₃ or CF₂OCF₃.

7. The mixture as claimed in claim 1, wherein Rf represents F, CF₃, CHF₂, C₂F₅, C₂F₄OCF₃, C₂H₂F₂OCF₃ or CF₂OCF₃.

8. The mixture as claimed in claim 1, wherein R₁ and R₂ independently represent F, CF₃, C₂F₅, C₂F₄OCF₃, C₂H₂F₂OCF₃ or CF₂OCF₃.

9. The mixture as claimed in claim 1, wherein the lithium salt of the X group is LiPF₆.

10. The mixture as claimed in claim 1, wherein the amount of each lithium salt present in the mixture represents between 1% and 99% by weight, with respect to the total weight of the lithium salts present.

11. The mixture as claimed in claim 1, wherein the mixture is prepared from corresponding lithium salts.

12. The mixture as claimed in claim 1, wherein the mixture it is dissolved in a solvent or several solvents.

13. The mixture as claimed in claim 12, wherein the solvent is chosen from carbonates and glymes.

14. An electrolyte comprising a mixture as claimed in claim 1.
